(19) United States
(12) Patent Application Publication
(10) Pub. No.: US 2007/0196017 A1
(43) Pub. Date: Aug. 23, 2007

(54) Management information adding method and image forming apparatus

(75) Inventors: Yohichi Shimazawa, Nara (JP); Yoshiyuki Nakai, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/644,745

(22) Filed: Dec. 21, 2006

(30) Foreign Application Priority Data
Feb. 17, 2006 (JP) 2006-040615

(51) Int. Cl. G06K 9/46

(52) U.S. Cl. 382/203

(57) ABSTRACT

A management information adding method are provided that when one piece of specific image information is detected, can detect from the specific image information the position or direction in which other specific image information is arranged and can improve the detecting speed of the specific image information as a whole. In adding the management information of a recorded image on the recorded image, the management information is formed by one or more pieces of specific image information and the specific image information is designed to have a shape indicating the position or direction in which other specific image information is arranged. A shape having a straight-line or angular element can be used as the shape of the specific image information indicating the position or direction of other specific image information. One piece of management information may be formed by combining plural pieces of specific image information.

### CROSS-NOTING PARAGRAPH

This Nonprovisional application claims priority under 35 U.S.C. § 119(a) on patent application No. 2006-040615 filed in JAPAN on Feb. 17, 2006, the entire contents of which are hereby incorporated herein by references.

### FIELD OF THE INVENTION

The present invention relates to a method of adding management information for image data on the image data of a document and an image forming apparatus.

### BACKGROUND OF THE INVENTION

To prevent unauthorized copying of a document composed of image data, an image of a specific pattern (hereinafter, specific image information) such as a background pattern is added to or combined with the document. This specific image information is also referred to as copy prohibiting information or copy preventing information. In addition to this, by implanting various types of management information such as date of preparation, writer, and expiry date into the image data of the document as hidden information, management is made possible.

The specific image information described above is, in some case, attached to the document in such a state as to be indiscernible to a user and in other case, attached to the document in such a state as to be sufficiently discernible to the user as the specific image information to restrain copying etc. However, irrespective of whether the specific image information is discernible to the user or not, when for example, the user attempts to copy the document with the specific image information added thereto using a copying machine, etc., the machine performs an operation such as prohibiting the document from being copied or printed or outputting information of “copy prohibited”.

With respect to copy prohibiting technology, for example, Japanese Laid-Open Patent Publication No. H07-38737 discloses a copying machine designed to easily prepare a document with a specific mark added thereto. In this patent application, the copying machine comprises a specific mark generating means for reproducing an image by adding a specific mark to a document image, a mark presence detecting means for detecting presence or absence of the specific mark in the read document image, and a controlling means for causing a copying operation to differ from the operation in an ordinary manner when the mark presence detecting means detects the specific mark from the document image.

Japanese Laid-Open Patent Publication No. H07-36325 discloses a copying machine designed to obtain a reproduced image that enables detection of the specific mark easily and accurately. In this patent application, in the copying machine having the function of reproducing the image with the specific mark added thereto by a mark adding means, the mark adding means adds to the document image the specific mark composed of a plurality of concentric circles of different diameters.

Generally, including the case of the above conventional arts, by adding (printing) the specific pattern image (specific image information) to the image data of the document and by reading thus printed image data and detecting the specific image information out of the image data, copy prohibiting information and detailed information regarding the read document are extracted. There are cases where documents contain, in addition to such information, plural pieces of management information such as the date of preparation, writer and expiry date or plural pieces of specific image information have respective pieces of related information, and it is necessary to detect plural pieces of specific image information and confirm the relationship among them.

However, the specific image information implanted in the image data is usually printed at random and often provided as hidden information and much time is required not only for image processing thereof and analysis of the information but also for the detection thereof itself.

### SUMMARY OF THE INVENTION

An object of the present invention is to provide a management information adding method and an image forming apparatus that, when one piece of specific image information is detected, can detect from the shape of such specific image information the position or direction in which other specific image information is arranged and thereby can improve the detecting speed of the specific image information as a whole.

In the management information adding method according to the present invention, when adding the management information of recorded image on the recorded image, the management information is formed by one or more pieces of specific image information and the specific image information is designed to have a shape indicating the position or direction in which other specific image information is arranged. A shape having a straight-line or angular element can be used as the shape of the specific image information indicating the position or direction of other specific image information. One piece of management information may be formed by combining plural pieces of specific image information.

### BRIEF DESCRIPTION OF THE DRAWINGS

FIG. 1 is a block diagram of an example of an image forming apparatus (digital multi-function peripheral) to which a management information adding method of the present invention is applied;

FIG. 2 is a block diagram of a schematic regarding an addition of specific image information in FIG. 1;

FIG. 3 is a block diagram of a schematic of a specific image information detecting portion in FIGS. 1 and 2;

FIG. 4 is a diagram of an example of the specific image information used in the present invention;

FIG. 5 is a diagram of another example of the specific image information used in the present invention;

FIG. 6 is a diagram of other example of the specific image information used in the present invention; and

FIG. 7 is a diagram of other example of the specific image information used in the present invention.

### PREFERRED EMBODIMENTS OF THE INVENTION

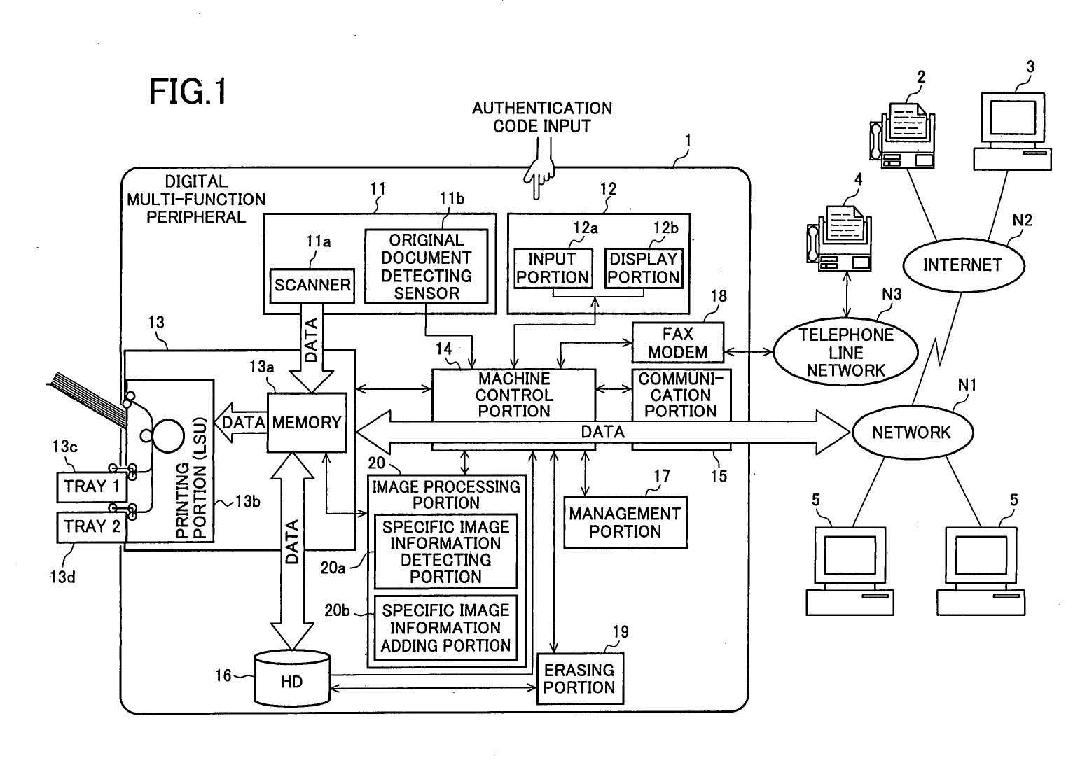

Description will be made of embodiments of the present invention, with reference to drawings. FIG. 1 is a block diagram of an example of an image forming apparatus (digital multi-function peripheral) to which a management information adding method of the present invention is applied. The digital multi-function peripheral 1 is connected to a plurality of personal computers (PC) 5 by way of a communication network N1 such as an in-house LAN and can exchange information with the PC 5. The digital multi-function peripheral 1 is also connected to a wide-area communication network N2 such as Internet to transmit and receive information to and from an external facsimile device 2 and an external PC 3, and can also communicate with other facsimile device 4 through a telephone line network N3.

This digital multi-function peripheral 1 has a plurality of functions, for example, as a copying machine, a printing device, a facsimile device, a scanning device, etc. The digital multi-function peripheral 1 is equipped with a machine control portion 14 comprising a CPU for arithmetic processing, a RAM for temporary storage of processing information, a ROM for storage of a control program, etc. This machine control portion 14 connects with a management portion 17 that stores management control information (various kinds of control information) that manages the processing performed by the digital multi-function peripheral 1 and with an image reading portion 11 that generates image data by reading an image, etc., recorded on recording paper. The image reading portion 11 has a scanner 11a for capturing the image data of a document and an original document detecting sensor 11b for detecting presence or absence of the document.

The machine control portion 14 connects with an image forming portion 13 that forms the image data on the recording paper. The image forming portion 13 is equipped with a memory 13a for temporary storage of read image data, a printing portion (LSU) 13b that forms the image from the image data stored in the memory 13a and prints the image on the recording paper, and trays 13c and 13d for feeding the recording paper to the printing portion 13b. By this configuration, the digital multi-function peripheral 1 serves as a copying machine that, after storing the image data generated at the image reading portion 11 in the memory 13a, forms the image at the printing portion 13b.

The machine control portion 14 is connected to a FAX modem 18 to transmit and receive to and from the facsimile device 4 by way of the telephone line network N3. Therefore, the machine control portion 14 can transmit the image data generated at the image reading portion 11 from the FAX modem 18 to other facsimile device 4 by way of the telephone line network N3. The machine control portion 14 can also receive the image data transmitted by other facsimile device 4 at the FAX modem 18 and form the image at the image forming portion 13. Namely, the digital multi-function peripheral 1 serves as a facsimile device.

Furthermore, because of its capability to transmit the image data read at the image reading portion 11 to the PC 5 by way of a communication portion 15, the digital multi-function peripheral 1 serves as a scanning device as viewed from the PC 5. Also, because of its capability to receive the image data transmitted by the PC 5 at the communication portion 15 and form the image from the received image data at the image forming portion 13, the digital multi-function peripheral 1 can also serve as a printing device as seen from the PC 5.

The communication network N1 is further connected to the wide-area communication network N2 such as Internet. The communication portion 15, by such a method as sending the image data attached to an e-mail, etc., can transmit and receive the image data to and from an Internet facsimile device 2 and the external PC 3 connected to the wide-area communication network N2, by way of the communication network N1 and the wide-area communication network N2. Therefore, the digital multi-function peripheral 1 can also serve as an Internet facsimile device.

An operation portion 12 for inputting by a user is connected to the machine control portion 14. The operation portion 12 has an input portion 12a such as a touch panel or a ten-key pad for inputting information such as a control command and a display portion 12b such as a liquid crystal display for displaying the information for operation. An authentication code, etc., for authenticating a manager or user of the digital multi-function peripheral 1 is also input at this operation portion 12. The authentication code is, in some cases, input from the outside by way of the FAX modem 18 or the communication portion 15.

Furthermore, a hard disk (HD) 16 is connected to the machine control portion 14. The HD 16 stores and retains the data related to image processing such as the image data generated by the image reading portion 11. The HD 16 is also connected to an erasing portion 19 that is connected to the machine control portion 14, and the erasing portion 19 erases the data stored and retained at the HD 16, as required. The machine control portion 14 connects with an image processing portion 20 equipped with a specific image information detecting portion 20a for detecting the specific image information and a specific image information adding portion 20b for adding the specific image information, both of which are used in the present invention.

The specific image information to be added to the image data is stored and retained beforehand at the specific image information adding portion 20b (or stored and retained at other accessible memory) and, by the control of the machine control portion 14, is temporarily memorized in the memory 13a in such a state that the specific image information is added to the image data. The image data retained in the memory 13a together with the specific image information is treated as a document provided with the specific image information (for example, copy prohibiting information), when printed on the recording paper at the printing portion 13b. In this case, the specific image information may be added in yellow (color machine) or gray (monochrome machine) in such a manner as not to be easily visible to the naked eye. Also when image forming is made at the printing portion 13b based on the image data read by way of the FAX modem 18 or the communication portion 15, the specific image information can be added by the specific image information adding portion 20b.

On the other hand, the image processing portion 20 has the specific image information detecting portion 20a for detecting whether the specific image information is contained in the image data read by the image reading portion 11. When the specific image information detecting portion 20a detects that the specific image information is contained in the image data, the machine control portion 14 executes the control, for example, to prohibit copying of the image data (to disable the image forming at the image forming portion 13).

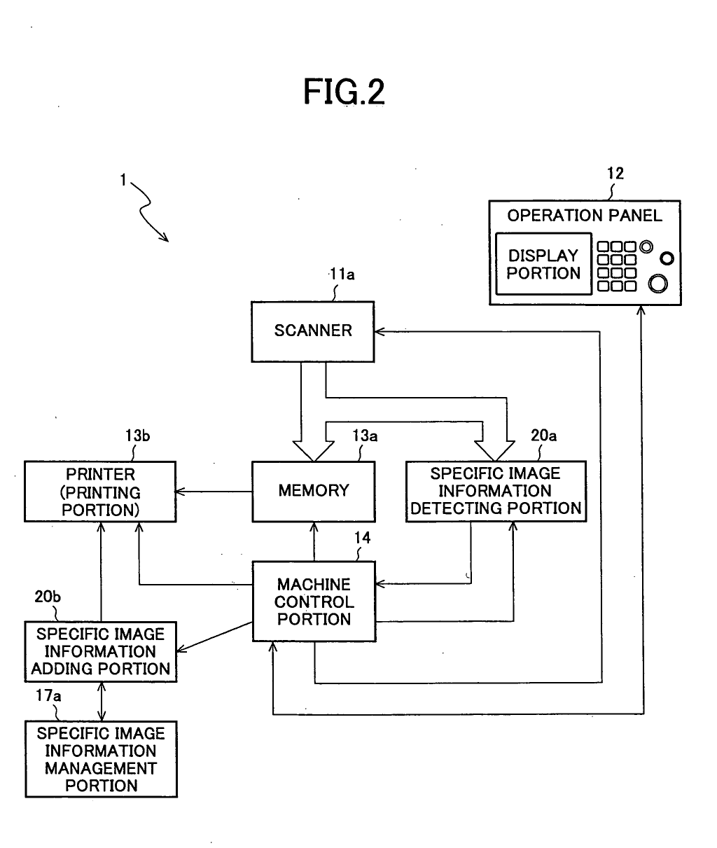

FIG. 2 is a block diagram of a schematic of configuration related to the addition of the specific image information of the present invention of FIG. 1. The digital multi-function peripheral 1 has an operation panel 12 for user's operation of printing, etc., after setting the document, etc., and a scanner 11a for reading the document. The image data of the document read by the scanner 11a is temporarily stored in the memory 13a and at the same time, the specific image information detecting portion 20a judges whether the specific image information is output to (whether the specific image information is included in) the image data of the document read by the scanner 11a.

The specific image information adding portion 20b adds predetermined specific image information to the image data stored at the memory 13a, based on predetermined conditions (for example, access right and processing route conditions). One or plural kinds of specific image information stored in a specific image information managing portion 17a are supplied to the specific image information adding portion 20b. The operation of adding the specific image information is performed by the printing portion (printer, etc.) 13b that outputs while adding (overlapping) the specific image information, based on the predetermined conditions described above, to the image data stored at the memory 13a and the machine control portion 14 that executes the control thereof.

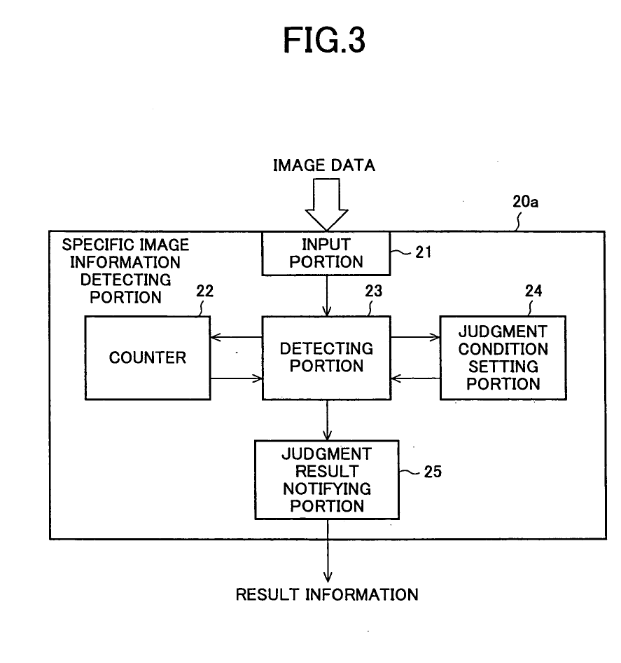

FIG. 3 is a block diagram of a schematic of the specific image information detecting portion 20a shown in FIGS. 1 and 2. The specific image information detecting portion 20a comprises an input portion 21 to which the specific image information read together with the image data is input and a detecting portion 23 that detects the specific image information out of input data. The specific image information detecting portion 20a further comprises a counter 22 that counts the number of times of detection of the specific image information detected at the detecting portion 23 and a judgment condition setting portion 24 that sets the criteria for judging the specific image information at the detecting portion 23. If the specific image information detected at the detecting portion 23 is determined to be, for example, the copy prohibiting information, then the results are notified to the machine control portion 14 by way of a judgment result notifying portion 25, and the machine control portion 14 controls so that the copying of the image data is prohibited.

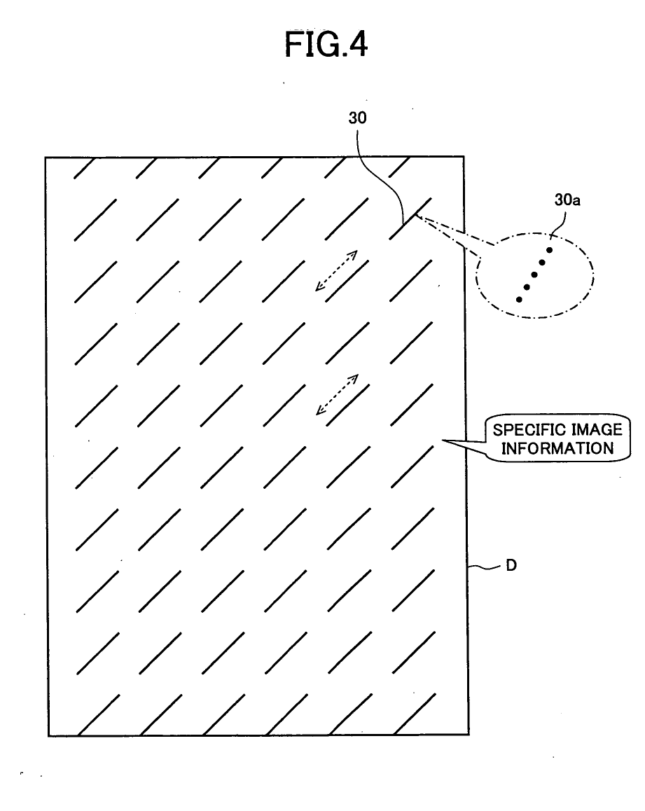

FIGS. 4 to 7 are explanatory diagrams of examples of the specific image information used in the present invention. Each of these pieces of the specific image information can be used alone as management information, but plural pieces of specific image information combined into a specific pattern may be used as one piece of management information. Therefore, when plural pieces of management information such as copy prohibition, date of preparation, writer, and expiry date are implanted into one document, it is necessary to prepare plural pieces of specific image information representing respective pieces of management information or a plurality of specific patterns, each formed by combining plural pieces of specific image information.

The specific image information, when added on the main face of the document D, is usually formed by an unobtrusive color (e.g., yellow) so as not to interfere with reading of the document, and is in some cases formed at an inconspicuous position as hidden information. The specific image information detecting portion converts the specific image information added in such manner to binarized information and thereafter judges by a pattern matching, etc. whether such binarized information is the specific image information. Only after such judging operation is performed as to plural pieces of specific image information to prevent erroneous detection, judgment is made that the predetermined management information is added, and a predetermined control such as copy prohibition is executed. Detection of the management information through such a course of detection is not easy and takes time.

In view of the above, the present invention is designed to provide the detected specific image information with such information that indicates the position or direction in which other specific image information is arranged so that when one piece of specific image information is detected, the specific image information to be read next can be speedily detected.

The specific image information shown in FIG. 4 is formed by, for example, a linear image pattern 30 slanted by the angle of 45°. This linear image pattern 30 is provided, for example, at a part of the document D or all over the document D. Forming of the specific image information by an angled image makes it possible to avoid the overlapping of the specific image information and horizontal and vertical ruled lines (e.g., image of a table, etc.) frequently used in ordinary image data. The linear image pattern 30 can be formed by arranging a plurality of dot-state images (dot images) 30a, with a predetermined space in between, in a straight line. In such a case, contents, etc., of the management information can be made to differ by changing the space between the dot images 30a or the number of dot images 30a.

The slanted linear image pattern 30 can be set to indicate, for example, that other linear pattern is present on an extension line of the straight line thereof. By such setting, when the linear image pattern 30 at a certain position of the document is detected, next linear pattern can be detected by searching for such pattern on the extension line thereof. Then, on the extension line of the next linear pattern and so forth, one linear pattern is detected after another, and when a predetermined number of linear image patterns 30 are detected, they are determined to be the predetermined management information and the control based on this management information can be executed.

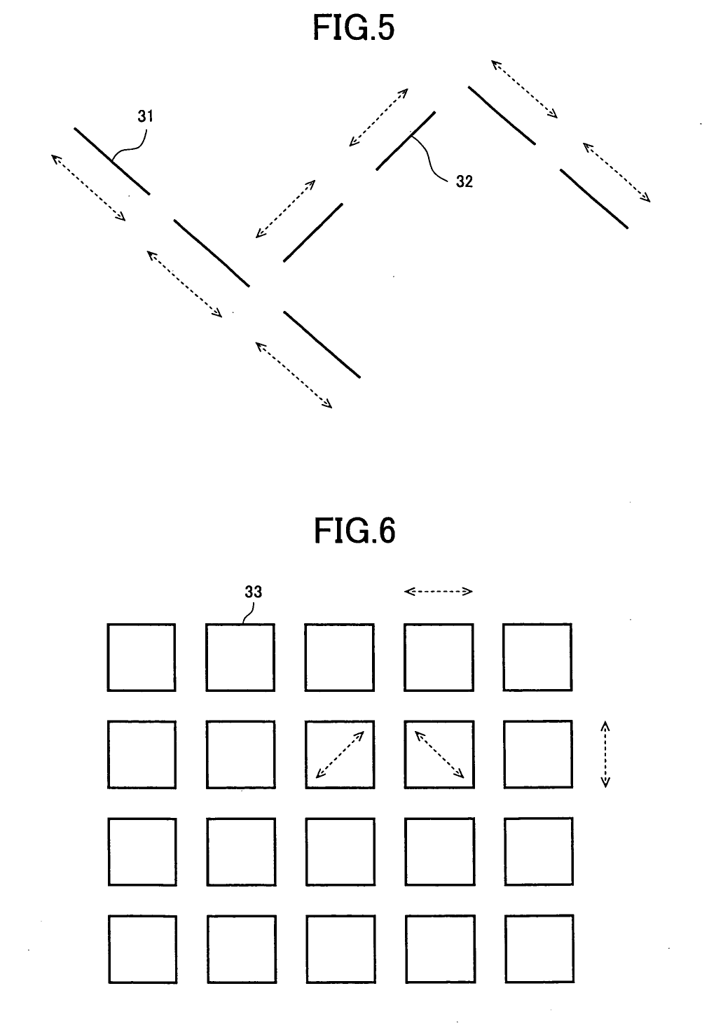

The specific image information shown in FIG. 5 represents an example of using two kinds of slanted linear image patterns 31 and 32 of different angular directions, a plurality of patterns for each kind, and in this case as well, just like the example of FIG. 4, each pattern can be formed by arranging a plurality of dot-state dot images, with a predetermined space in between, in a straight line. Feature of elemental shape of the linear image patterns 31 and 32 can indicate the position or direction in which the next linear pattern is arranged. By making a certain number of combinations of linear image patterns 31 and 32 of different directions, the management information of different contents can be made available, and it becomes easy to add plural pieces of management information.

In the example of FIG. 5, it can be so arranged that when one linear image pattern 31 or 32 that is the specific image information is detected, the linear pattern indicates that other linear pattern is present on an extension line of the linear pattern. There can be a plurality of other linear patterns, instead of one, on the extension line. In such a case, detection may be made of all of the plurality of linear patterns on the extension line or may be made of only the linear patterns in a particular direction. Then, the next linear pattern is detected and one linear pattern is detected after another, and when a predetermined number of linear patterns are detected or a specific pattern formed by combining linear patterns is detected, such pattern or patterns are determined to be the predetermined management information and the control based on this management information can be executed.

The specific image information shown in FIG. 6 represents an example of using a plurality of rectangular image patterns 33, and in this case as well, just like the example of FIG. 4, the rectangular image pattern 33 can be formed by arranging a plurality of dot-state dot images, with a predetermined space in between. This rectangular image pattern 33, by the feature of elemental shape of a straight-line part or a corner of a rectangle, can indicate the position or direction in which the next rectangular pattern is arranged. Size of the rectangular image pattern 33 or a plurality of image patterns can be grouped as one piece of management information and, by changing the form of the grouping, management information of different contents can be made available.

In the example of FIG. 6 as well, it can be so arranged that when one rectangular image pattern 33 that is the specific image information is detected, the rectangular pattern indicates that other rectangular pattern is present in the direction of an extension line of vertical and horizontal straight-line parts that are featured parts of the rectangular pattern and in the direction of the extension line of a diagonal connecting two opposing corners. There can be a plurality of other rectangular patterns, instead of one, in the direction of the extension line. In such a case, detection may be made of all of the plurality of rectangular patterns in the direction the extension line or may be made of only the rectangular patterns in a particular direction. Then, other rectangular pattern in the direction of the extension line of the next rectangular pattern is detected, and one rectangular pattern is detected after another, and when a predetermined number of rectangular patterns are detected or a specific pattern formed by combining rectangular patterns is detected, such pattern or patterns are determined to be the predetermined management information and the control based on this management information can be executed.

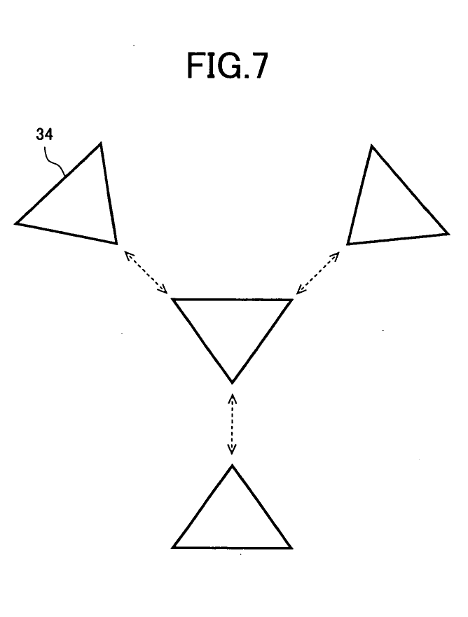

The specific image information shown in FIG. 7 represents an example of using a plurality of triangular image patterns 34, and in this case as well, just like the example of FIG. 4, the triangular pattern can be formed by arranging a plurality of dot-state dot images, with a predetermined space in between. This triangular image pattern 34, by the feature of elemental shape of a straight-line part or a vertex thereof, can indicate the position or direction in which the next triangular pattern is arranged. Size of the triangular image pattern 34 or a plurality of image patterns can be grouped as one piece of management information and, by changing the form of the grouping, management information of different contents can be made available.

In the example of FIG. 7 as well, it can be so arranged that when one triangular image pattern 34 that is the specific image information is detected, the triangular pattern indicates that other triangular pattern is present in the direction of an extension line of the vertex that is a featured part of the triangular pattern. There can be a plurality of other triangular patterns, instead of one, in the direction of the extension line. In such a case, detection may be made of all of the plurality of triangular patterns in the direction of the extension line or may be made of only the triangular patterns in a particular direction. Then, other triangular pattern in the direction of the extension line of the next triangular pattern is detected, and one triangular pattern is detected after another, and when a predetermined number of triangular patterns are detected or a specific pattern formed by combining triangular patterns is detected, such pattern or patterns are determined to be the predetermined management information and the control based on this management information can be executed.

As described above, in the present invention, the specific image information is provided with the information indicating the position or direction in which other specific image information is arranged. Since the specific image information usually is inconspicuously formed as hidden information or is provided in distant positions, it takes time to access the specific image information to be read next. However, by indicating in advance the position or direction of the specific image information to be read next, the access to the next specific image information can be made in a short time. As a result, if one piece of specific image information is found out, then the predetermined number of pieces of specific image information can be detected, one after another, in a short time, and the operation time required for reading out and identifying the management information can be shortened.

In the use of an apparatus equipped with the function of adding the specific image information described above, there are cases where, for the purpose of confirming the state of operation of the apparatus, confirmation is made of whether the specific image information has actually been added to the document, etc., and verification is made of whether the specific image information can correctly be detected. In such cases, usually, a visual inspection is made to find out whether the specific image information is added, but when the specific image information is added to the document in remote locations at random, the information can not be easily found out. However, when the specific image information has the shape indicating the position or direction of other specific image information as described above, the verification work can be easily conducted.

As seen above, according to the present invention, when one piece of specific image information is detected, by reading the feature of the pattern shape, etc., of the specific image information, knowledge can be gained of the position or direction of other specific image information, detection can speedily be made of the specific image information to be read next, and overall reading out and detection of the management information can be expedited.

1. A management information adding method that is a method of adding management information of a recorded image on the recorded image, wherein
the management information is formed by one or more pieces of specific image information, wherein
the specific image information has a shape indicating the position or direction in which other specific image information is arranged.

2. The management information adding method as defined in claim 1, wherein
the specific image information has a straight-line or angular element to indicate the position or direction of other specific image information.

3. The management information adding method as defined in claim 1 or 2, wherein
the management information is formed by combining plural pieces of the specific image information.

4. An image forming apparatus equipped with a specific image information adding portion that adds management information of a recorded image on the recorded image, wherein
the management information is formed by one or more pieces of specific image information, wherein
the specific image information has a shape indicating the position or direction in which other specific image information is arranged.
